(19) United States
(12) Patent Application Publication
(10) Pub. No.: US 2009/0318087 A1
(43) Pub. Date: Dec. 24, 2009

(54) Method and Device for Preventing Interference at a Radio Receiver Device Caused by Several Radio Transmitter Devices

(76) Inventors: Heikki O. Mattila, Oulu (FI); Mauri Honkanen, Tampere (FI); Niko Kiukkonen, Veikkola (FI)

Correspondence Address: Locke Lord Bissell & Liddell LLP;Attn: IP Docketing, Three World Financial Center, New York, NY, 10281-2101, US

(21) Appl. No.: 12/224,184

(22) PCT Filed: Feb. 20, 2006
(86) PCT No.: PCT/IB2006/000329

§ 371 Date: Oct. 10, 2008

(51) Int. Cl. H04B 15/00

(52) U.S. Cl. 455/63.1

(57) ABSTRACT

The present invention provides a method for reducing interference at a radio receiver device caused by several radio transmitter devices, comprising the steps of detecting simultaneous operation of at least two radio transmitter devices and a radio receiver device, determining that said simultaneous operation of said transmitter devices causes interference through frequency intermodulation effects at said radio receiver device, and controlling at least one of said radio transmitter devices and/or said radio receiver device, in order to reduce said interference.

The invention furthermore provides a device for reducing interference between a radio receiver device and several radio transmitter devices, comprising a detection component, adapted for detecting simultaneous operation of at least two radio transmitter devices and a radio receiver device, and for determining that said simultaneous operation of said transmitter devices causes interference through frequency intermodulation effects at said radio receiver device, and a controller responsive to said detection component, adapted for controlling at least one of said radio transmitter devices and/or said radio receiver device for reducing said interference.

The present invention relates to the field of mobile terminal devices comprising a radio receiver device and several radio transmitter devices. The invention is particularly concerned with minimizing noise/interference encountered in a GPS/Galileo receiver, wherein the noise/interference is caused by harmonic and intermodulation effects of several simultaneously operating radio transmitter devices.

Various radio frequency (RF) interfaces have been developed recently for different purposes. Just as a few examples there are the well-known Wireless LAN standard for wireless networking, the multi-purpose Bluetooth standard for peripheral devices and wireless networking, as well as a number of cellular telecommunication standards like GSM (global standard for mobile communication) or UMTS (universal mobile telecommunication standard). Therefore an increasing number of different radio interfaces will be integrated into mobile terminals in the future. For example there are already known PDAs or smartphones comprising a cellular telecommunication interface, WLAN and Bluetooth (BT).

Expanding the range of different applications requires radio access methods/interfaces with different data rate, range, robustness and performance, which results in scenarios wherein mobile terminal devices will have multiple or several, respectively, radio devices. This in turn will lead to associated problems within such mobile terminals. Means will be required for coordinating the usage of both terminal hardware/software and radio resources, that is, usage of the air interface without mutual interference.

There are already a number of known cases where one radio device in a mobile terminal generates a powerful wanted signal or an excessive amount of noise and/or spurious responses from its antenna, and thus operation of another radio device within the same terminal is subjected to significant interference or even gets totally blocked. Two well-known examples are related to the interference situation between simultaneously operating 2.4 GHz WLAN and Bluetooth devices, as well as the detrimental interference caused by a cellular transmitter (at 824-849 MHz) to a DVB-H receiver (at 1670-1675 MHz) located in the same terminal.

Radio receiver devices, e.g. a GPS (global positioning system) receiver or a receiver for the upcoming Galileo system, are likely to become very common equipment in mobile terminal devices. In some countries there exist requirements, according to which a mobile terminal must be able to provide its position with a pre-determined accuracy when placing emergency calls. However, when multiple other radio devices are integrated into a single device comprising the radio receiver device, situations may occur where GPS/Galileo reception is desensitized or maybe even blocked by the combined interference from those other radio devices.

It is quite well-known that a terminal with multiple radio devices, comprising a GPS receiver and typically a set of other radio devices, both cellular (e.g. GSM, WCDMA, CDMA2K) and complementary ones (e.g. WLAN, Bluetooth and DVB-H), creates a design challenge related to the interference coupling from one RF system to another. This is due to the small dimensions of a typical handset, forcing the designer to place the radio devices and their associated antennas within close proximity to each other. Hence, the antenna coupling losses between the radio devices will be comparably small.

Typically the transmission powers in both cellular and complementary systems are so high that the wanted signal itself might generate interference that is not sufficiently attenuated by the receiver filters. Alternatively, unwanted transmitter spurious signals and noise might fall in the receiver's pass band and hence the receiver's filters can not provide any rejection of this interference.

A GPS/Galileo receiver is able to detect and synchronize to very weak signals coming from the distant satellites, i.e. its sensitivity is very high. Typical sensitivity figures range from −145 dBm to −135 dBm, depending on the availability of assistance from the cellular systems. In order to keep the dynamic range of the GPS receiver realizable, its linearity has to be reasonable and hence the strongest interfering signals need to be taken care by means of filtering rather than increasing linearity.

Out-of-band interference coming from another system (e.g. a GSM 900 transmitter in the same terminal) is handled by the external and internal front-end filters of the GPS receiver. Respectively, the in-band interference due to the spurious signals and noise from a transmitter (e.g. the GSM 900 transmitter in the same terminal) are handled by a careful transmitter design and/or rejection provided by the transmitter's filtering. Naturally, the coupling loss between the system antennas alleviates the situation. These interference problems originating from a single source (i.e. single other RF device) are straight-forward to solve. However, there is a severe problem when the interference is generated nonlinearly by two or more radio transmitter devices operating simultaneously.

When two signals with frequencies f1 and f2 are applied simultaneously to a nonlinear receiver device, according to well-known polynomial approximations the nonlinearity creates harmonics and intermodulation products at frequencies

f_{m,n}=m·f₁+n·f₂, where m, n are integers 0, ±1, ±2, ±3 . . .

The smaller the order (i.e. |m|+|n|) of an intermodulation product, the higher the power of that signal is typically. The concept of intermodulation or mixing products can be expanded to three or more signal sources with more complex intermodulation combinations.

When considering an exemplary case as depicted in FIG. 1, a GPS receiver, a GSM 850/900 transmitter and a Bluetooth/WLAN transmitter are located in a mobile terminal, wherein the transmitters and the receiver are operating simultaneously. Most probably neither of the radio devices alone will generate any significant interference to another system, but when the GSM 850/900 transmission and the Bluetooth/WLAN transmission are combined in a nonlinear process in the front-end of the GPS receiver, a harmful second order interfering intermodulation signal is generated according to the abovementioned equation, with m=+1, f1=2400-2483.5 MHz, n=−1, f2=880-915 MHz.

The intermodulation result ranging from 1485 MHz to 1603 MHz (depending on the channel used in both systems) overlaps the GPS L1 center frequency of 1575.42 MHz (bandwidth approximately 20 MHz). Obviously, the intermodulation product cannot be rejected by means of filtering in the GPS receiver, because it is located in the same system band as the wanted GPS signal. Hence severe interference takes place due to the typically high signal powers in question and the very limited coupling loss between the antennas.

Similarly, when cdma2000/GSM 850 MS TX frequencies of 824.025-848.985 MHz are assumed for f2, intermodulation products are generated ranging from 1551 MHz to 1659 MHz, thus also overlapping with the GPS L1 reception band. In practice, it is not feasible to design a GPS receiver such that it can tolerate this sort of interference all the time, due to power consumption constraints.

The problem described above with simultaneous transmission of a GSM/cdma2000 transmitter at the 850/900 MHz band and a Bluetooth/WLAN device at 2.4 GHz band is not the only case producing harmful interference. Moreover, the radio devices generating the intermodulation interference need not be in the same terminal, since the interference power levels considered to be harmful can be very small. In general, the problem relies in the fact that when two or more radio devices (transmitters) operate simultaneously within the terminal or nearby, the combined effect of the transmitters produces interference which desensitizes or even blocks the operation of GPS receiver.

The following is a non-exclusive list of possible interference generation mechanisms describing some exemplary cases:
Simultaneous GSM850/900 and WLAN/Bluetooth transmissions in the same device result in second order intermodulation (IMD2) interference occurring at the GPS/Galileo band (1575.42 MHz)
DCS 1800 transmitting in the device itself, and a WCDMA mobile in close range thereto (˜1 m) results in third-order (IMD3) interference occurring at the GPS/Galileo band (1575.42 MHz)
GSM 1900/CDMA 1900 TX (device itself) and WLAN (5 GHz) TX (in the same or in another device) results in IMD3 interference at the GPS/Galileo band (1575.42 MHz)

The straight-forward prior art method of solving the problem is to eliminate the interferences by filtering in the uplink transmitters and/or the GPS/Galileo receiver. However, addition of filters is costly and consumes precious circuit area on the board. Another prior art solution is to simply blank out the GPS reception while e.g. a GSM transmitter is active. The blanking causes performance degradation of ˜3 dB in GPS in case of single slot GSM transmissions (the effect is even more severe in cases of multi-slot transmissions).

These prior art solutions are disadvantageous with respect to the design and production of related devices due to the necessary integration of sophisticated filtering means. Furthermore simple solutions like the blanking of GPS reception while a GSM or other transmitter is active are not acceptable, e.g. in the above mentioned case of an emergency call where the position of the person placing the call has to be determined quickly. Also the prior art does not address the problem of interference being caused by the combined effects of two or more radio devices operating simultaneously.

Accordingly it is an object of the present invention to provide means for solving these problems. The invention is particularly concerned with the situation where the origin of the interference and its generation mechanism is different from the prior art one-to-one situations (a single device other interfering), that is, when two or more simultaneously operating radio transmitter devices together generate an interference in a radio receiver device (e.g. in the victim receiver's front-end).

### SUMMARY OF THE INVENTION

According to an aspect of the present invention a method is provided for reducing interference at a radio receiver device caused by several radio transmitter devices, comprising:
detecting simultaneous operation of at least two radio transmitter devices and a radio receiver device;
determining that said simultaneous operation of said transmitter devices causes interference through frequency intermodulation effects at said radio receiver device; and
controlling at least one of said radio transmitter devices and/or said radio receiver device, in order to reduce said interference.

The simultaneous operation of two (or more) radio transmitter devices can cause so-called intermodulation effects in a non-linear radio receiver device. If such undesired interferences fall into the reception frequency or band of the receiver, a reception of wanted signals may be reduced or even completely blocked. The present invention provides a method for dealing with this interference situation, and can thus help to improve the interoperability of radio devices, particularly when implemented in a single mobile electronic device.

According to an exemplary embodiment said controlling comprises:
scheduling the operation of at least one of said radio transmitter devices and/or of said radio receiver device in time domain, in order to prevent simultaneous operation of said radio transmitter devices and said radio receiver device.

Time domain scheduling is easy to implement, and will though completely eliminate the intermodulation effects, as the operation of the radio devices will not overlap in time any longer. In the context of the present invention the time scheduling may be performed at one (or all) of the transmitter devices (transmission, TX) as well as at the receiver device (reception, RX), depending on the types of involved radio devices and the situation encountered.

According to an exemplary embodiment said controlling comprises:
changing the transmission frequency of at least one of said radio transmitter devices and/or the reception frequency of said radio receiver device, in order to reduce said frequency intermodulation effects at said radio receiver device.

Performing the controlling in frequency domain is another easy way of reducing or even preventing the intermodulation effects. As the frequency of the occurrence of these effects is a function of the frequencies involved, changing the frequency allows a simple and flexible reaction to the occurrence of such interferences. Many RF interfaces already have implemented such frequency change features which may be used by the present invention, as e.g. the different WLAN channels, Bluetooth channels or GSM frequency bands (900, 1800).

According to an exemplary embodiment the method further comprises:
restricting the change of the transmission or reception frequencies to pre-determined frequencies.

This embodiment is particularly useful for RF interfaces having a kind of frequency hopping implemented, like Bluetooth. Restricting such features to those frequencies which are known to be advantageous from interference point of view enables for improved connectivity.

According to an exemplary embodiment said controlling comprises:
increasing the linearity of said radio receiver device, in order to reduce said frequency intermodulation effects at said radio receiver device.

As the intermodulation is caused by non-linearity within the receiver, increasing the linearity can help to reduce the interference. As it is practically unfeasible to design GPS receivers or like such that they can tolerate this interference for a long time, it is advantageous to boost the linearity only on demand. The power consumption, which is raised by the linearity increase, can thus be controlled.

According to an exemplary embodiment said controlling comprises:
determining a priority of the operation of said radio transmitter devices and/or said radio receiver device; and
performing said controlling of said radio transmitter devices and/or said radio receiver device in accordance with said priority.

It is important to prioritize certain link types over others. For example a GSM cellular link is more important for a user than a connection between his mobile terminal and his personal computer. Therefore it is preferred that lower priority radio transmitter devices and/or receiver devices are controlled first, such that the connectivity of higher priority radio links can be maintained as good as possible.

According to an exemplary embodiment said controlling is performed by sending a message to said at least one of said radio transmitter devices and/or said radio receiver device, said message including instructions for controlling said at least one of said radio transmitter devices and/or said radio receiver device. This particularly relates to cases where e.g. an interfering transmitter device is not located within a mobile terminal performing the inventive method. In this case the device can not directly control the interfering device for reducing/eliminating the interference. However, this embodiment enables control also of such “external” devices. By sending such control messages other terminals or base stations/access points or the like can be informed about the interference occurrence, and are thus enabled to perform controlling in order to reduce/eliminate the interference.

According to an exemplary embodiment said radio receiver device is
a broadcast (e.g. DVB, MediaFLO) receiver;
a positioning system (e.g. GPS, Galileo) receiver;
a cellular telephone (e.g. GSM, WCDMA, CDMA2K) receiver;
a wireless local area network (WiFi) receiver;
a wireless personal area network (e.g. Bluetooth, UWB) receiver; or
a wireless metropolitan area network (e.g. WiMAX) receiver;

According to an exemplary embodiment each of said radio transmitter devices is selected from the group comprising:
a cellular telephone (e.g. GSM, WCDMA, CDMA2K) transmitter;
a wireless local area network (WiFi) transmitter;
a wireless personal area network (e.g. Bluetooth, UWB) transmitter; and
a wireless metropolitan area network (e.g. WiMAX) transmitter.

According to another aspect of the present invention a computer program product is provided, comprising program code means stored on a computer readable medium for carrying out the methods described above, when said program product is run on a computer or network device.

According to yet another aspect of the present invention a computer data signal embodied in a carrier wave and representing program code means is provided, the data signal being adapted for instructing a computer or network device to carry out the methods described above.

According to still another aspect of the present invention a device for reducing interference between a radio receiver device and several radio transmitter devices, is provided, comprising:
a detection component, adapted for detecting simultaneous operation of at least two radio transmitter devices and a radio receiver device, and for determining that said simultaneous operation of said transmitter devices causes interference through frequency intermodulation effects at said radio receiver device; and
a controller responsive to said detection component, adapted for controlling at least one of said radio transmitter devices and/or said radio receiver device for reducing said interference.

According to an exemplary embodiment said controller is further adapted for:
scheduling the operation of at least one of said radio transmitter devices and/or of said radio receiver device in time domain, in order to prevent simultaneous operation of said radio transmitter devices and said radio receiver device.

According to an exemplary embodiment said controller is further adapted for:
changing the transmission frequency of at least one of said radio transmitter devices and/or the reception frequency of said radio receiver device, in order to reduce said frequency intermodulation effects at said radio receiver device.

According to an exemplary embodiment said controller is further adapted for:
restricting the change of the transmission or reception frequencies to pre-determined frequencies.

According to an exemplary embodiment said controller is further adapted for:
increasing the linearity of said radio receiver device, in order to reduce said frequency intermodulation effects at said radio receiver device.

According to an exemplary embodiment said controller is further adapted for:
determining a priority of the operation of said radio transmitter devices and/or said radio receiver device; and
performing said controlling of said radio transmitter devices and/or said radio receiver device in accordance with said priority.

According to an exemplary embodiment said controller is further adapted for performing said controlling by sending a message to said at least one of said radio transmitter devices and/or said radio receiver device, said message including instructions for controlling said at least one of said radio transmitter devices and/or said radio receiver device. In principle the device may be equipped with its own interface for sending these messages, e.g. radio interface, infra-red interface, Bluetooth etc. However, it is preferred that the respective interfaces of a mobile terminal this device is built into are used in a shared manner.

According to a further aspect of the present invention a mobile electronic device is provided, comprising a device as described above.

According to an exemplary embodiment the mobile electronic device further comprises a radio receiver device. In exemplary embodiments said radio receiver device is selected from the group comprising
a broadcast (e.g. DVB, MediaFLO) receiver;
a positioning system (e.g. GPS, Galileo) receiver;
a cellular telephone (e.g. GSM, WCDMA, CDMA2K) receiver;
a wireless local area network (WiFi) receiver;
a wireless personal area network (e.g. Bluetooth, UWB) receiver; or
a wireless metropolitan area network (e.g. WiMAX) receiver.

According to an exemplary embodiment the mobile electronic device further comprises at least two radio transmitter devices. In exemplary embodiments said radio transmitter devices are selected from the group comprising
a cellular telephone (e.g. GSM, WCDMA, CDMA2K) transmitter;
a wireless local area network (WiFi) transmitter;
a wireless personal area network (e.g. Bluetooth, UWB) transmitter; and
a wireless metropolitan area network (e.g. WiMAX) transmitter.

### BRIEF DESCRIPTION OF THE DRAWINGS

FIG. 1 describes the principles of the interference generation in a conventional mobile terminal;

FIG. 2 is a schematic view of an arrangement of a conventional mobile terminal as in FIG. 1;

FIG. 3 illustrates an exemplary solution for a time-domain scheduling solution in case of GPS, GSM 900 and Bluetooth eSCO, according to an embodiment of the present invention;

FIG. 4 illustrates an exemplary solution of the present invention, being performed in frequency domain;

FIG. 5 is a flow diagram showing an embodiment of the inventive method; and

FIG. 6 shows a schematic view of an embodiment of the device according to the invention.

### DETAILED DESCRIPTION OF THE PRESENT INVENTION

In the following description the examples will be focused on the use of a GPS receiver as radio receiver device. However, it should be noted that also other positioning system receivers like one for the upcoming Galileo system and also other types of receiver devices can be used in the present invention. Just as an example a DVB-H receiver shall be mentioned, however the invention is not limited to those examples. The reception capability of every radio receiver device can be improved with the invention. Also, it should be noted that in the following examples GSM, WLAN and BT are mentioned as examples of interfering transmitters, while the invention is not limited to these particular transmitters, but can be applied to all other types of transmitter devices as well. The invention can be applied to any combination of two or more interfering transmitters and a receiver device, wherein interference to the receiver is generated.

It is also to be noted that the present invention includes both controlling the transmission (TX) as well as controlling the reception (RX) operation situation/parameters of involved radio devices, depending on the actual combination of radio devices and the circumstances encountered. That is, controlling one or more of the transmitter devices, the receiver device, or combinations thereof.

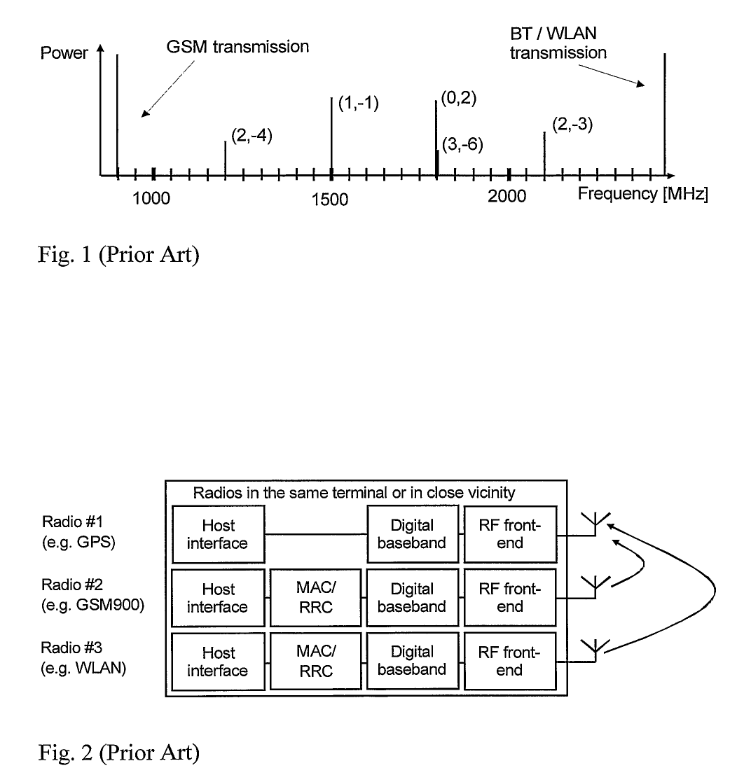

FIG. 1 is a spectral diagram illustrating the occurrence of intermodulation interferences, with frequency shown on the horizontal axis, and signal strength on the vertical axis. Here only a fraction of the spectrum and the possible intermodulation components are shown. Intermodulation interferences are generated according to the formula:

f_{m,n}=m·f₁+n·f₂, where m, n are integers 0, ±1, ±2, ±3 . . .

The coefficients (m, n) of generated signals are shown in brackets. In this figure a GSM transmission and a Bluetooth (BT) or WLAN transmission are assumed. As indicated by the extension on the vertical axis those two transmissions are the strongest signals shown here. According to the above formula intermodulation signals, that is, interferences are generated at certain frequencies. The frequency of f₁, is assumed to be about 2400-2483.5 MHz, and f₂ is about 880-915 MHz. The actual values are exemplary and are only provided for illustrative purposes, as are the values of the occurring interference signals.

At a frequency of about 1.5 GHz and another frequency of about 1.8 GHz two substantially similarly strong interference signals are illustrated, with m=1, n=−1 and m=0, n=2. Two weaker signals are generated at 1.2 GHz=1200 MHz, with m=2 and n=−4, and another interference occurs at 2.1 GHz, with m=2 and n=−3. The weakest interference signal in this diagram occurs at a frequency of about 1.8 GHz with m=3 and n=−6. It has to be noted that here only the center frequencies are shown for better intelligibility. In reality the interfering signals are distributed around that frequency.

The GPS reception Band L1 is located at about 1.5 GHz. Therefore it is clear from this exemplary diagram that the combined or simultaneous operation of the BT/WLAN device and the GSM device creates an interfering signal affecting GPS reception. The prior art does not provide any means for dealing with this kind of interference, which results from the combined operation of two (or more) transmitters.

FIG. 2 is a schematic view of an arrangement comprising three radio frequency devices (#1, #2, #3), two transmitters and one receiver, in accordance with the situation depicted in FIG. 1. The transmitters may e.g. be a GSM 900 device and a WLAN device, while the receiver may be a GPS receiver. All three devices comprise a host interface, a digital baseband and an RF front-end connected to an antenna. The transmitter devices #2 und #3 also comprise a Media Access Control/Radio Resource Control (MAC/RRC). Intermodulation products are generated in the non-linear front-end of then radio receiver #1 (as illustrated in FIG. 1).

That is, the transmissions from devices #2 and #3 from their antennas couple to the receiver's antenna. It should be noted that the three devices may be located in the same mobile electronic device, or may be located in close vicinity to each other. In the former case the coupling losses between the antennas will apparently be comparably small, or in other words the antenna coupling will be rather strong, due to the restrictions caused by the size considerations of mobile devices. In both cases the emissions at frequencies f₁ and f₂ of transmitter #2 and #3, respectively, couple to the antenna of the radio receiver #1. In the situation already described in conjunction with FIG. 1 the GPS receiver #1 will be disturbed due to the intermodulation products falling into its reception band.

In FIGS. 1 and 2 the problems have been illustrated that can occur in prior art devices having multiple radio devices, one receiver and at least two transmitters.

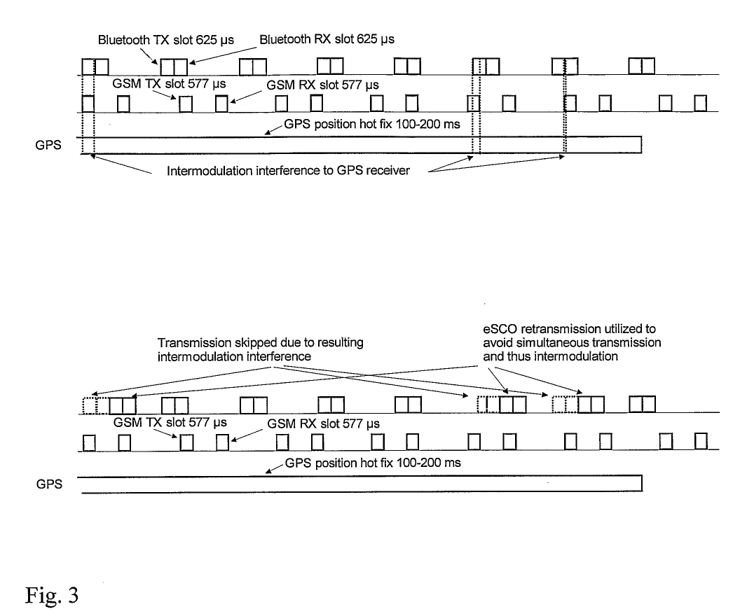

FIG. 3 is a schematic view of an exemplary solution according to the invention for scheduling the operation of transmitters in time domain. In the depicted example it is assumed that a GPS receiver device is operating simultaneously with an eSCO capable Bluetooth device and a GSM 900 transceiver. On the horizontal axis the time is indicated. In vertical direction the Bluetooth device, the GSM device and the GPS device are arranged in descending order.

The GSM 900 device transmits and receives in slots indicated by GSM TX slots and GSM RX slots, respectively. The duration of these slots is 577 μs. A transmit or TX slot is followed by a receive or RX slot, in the depicted regular succession. The Bluetooth device also transmits and receives in TX and RX slots, respectively. The duration of these slots is 625 μs. Each TX slots is directly followed by an RX slot.

As can be taken from the figure, there are periods of time when both the Bluetooth as well as the GSM device are transmitting simultaneously, with a different amount of overlapping in time domain (three occurrences in this fig.). To the left of the figure a substantially full overlap can be seen, while the remaining two overlap events have a reduced overlap in time. All of these do disturb the GPS receiver's position fix procedure, with duration of some hundred milliseconds.

In the lower half of this figure the inventive solution according to a particular embodiment is depicted. It should be noted here that the priority of GSM and Bluetooth device transmissions is apparently different. GSM transmissions should have a higher priority, which should be apparent. Therefore the solution in this particular example relies on making use of a special Bluetooth feature for manipulating the Bluetooth transmission.

According to the eSCO capability the Bluetooth device is enabled to perform so-called retransmissions. In the present invention the Bluetooth device is controlled to make use of this feature, in order to prevent the occurrence of intermodulation interferences, while at the same time keeping up the (higher priority) GSM connection undisturbed. That is, the transmission times of the Bluetooth TX slots are shifted in time domain. The “original” times which would cause interference to the GPS receiver are depicted with dashed boxes here.

The shifted TX (also RX) slots are shown in solid lines. As can be seen, the overlapping in time domain is avoided by the use of the eSCO retransmission feature. As the TX slots of GSM transceiver and Bluetooth transceiver do not take place simultaneously anymore, the intermodulation interferences are effectively prevented. The GPS receiver can operate properly without disturbances, and also the GSM (speech or other) connection can be maintained. The Bluetooth connection will only be affected marginally, which should not be noted by the user.

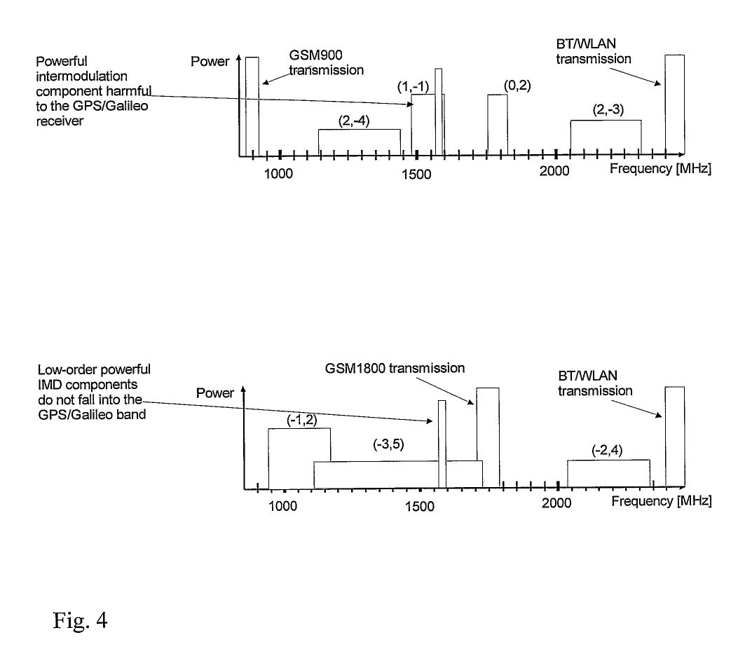

FIG. 4 illustrates an exemplary solution of the present invention, being performed in frequency domain. Similarly to FIG. 1 this figure shows on the horizontal axis the frequency, and the signal strength is indicated on the vertical axis. Assuming the same situation as already described in connection with FIG. 1, there is a GSM 900 transmission at frequency ˜900 MHz, and a BT/WLAN transmission at about 2.4-2.5 GHz. A powerful intermodulation component is generated at about 1.5-1.6 GHz, which is harmful for a GPS receiver as it falls into its L1 reception band.

According to an embodiment of the present invention one solution to this situation is to perform a scheduling in frequency domain, compared to the solution depicted in FIG. 3 which is related to scheduling in time domain. Assuming that the GSM transmitter is a dual-mode GSM 900/1800 transmitter, the GSM device is ordered to change its operation such that the 1800 band is used rather than the 900 band. This situation is depicted in the lower half of FIG. 4, where the GSM 1800 transmission is shown at ˜1.7 GHz.

Due to the performed frequency change there are only high order low power intermodulation (IMD) interferences falling into the GPS receiver band in this new situation. The scheduling in frequency domain according to the present invention has thus reduced the interference to the GPS receiver, while having maintained both the BT/WLAN as well as the GSM connectivity.

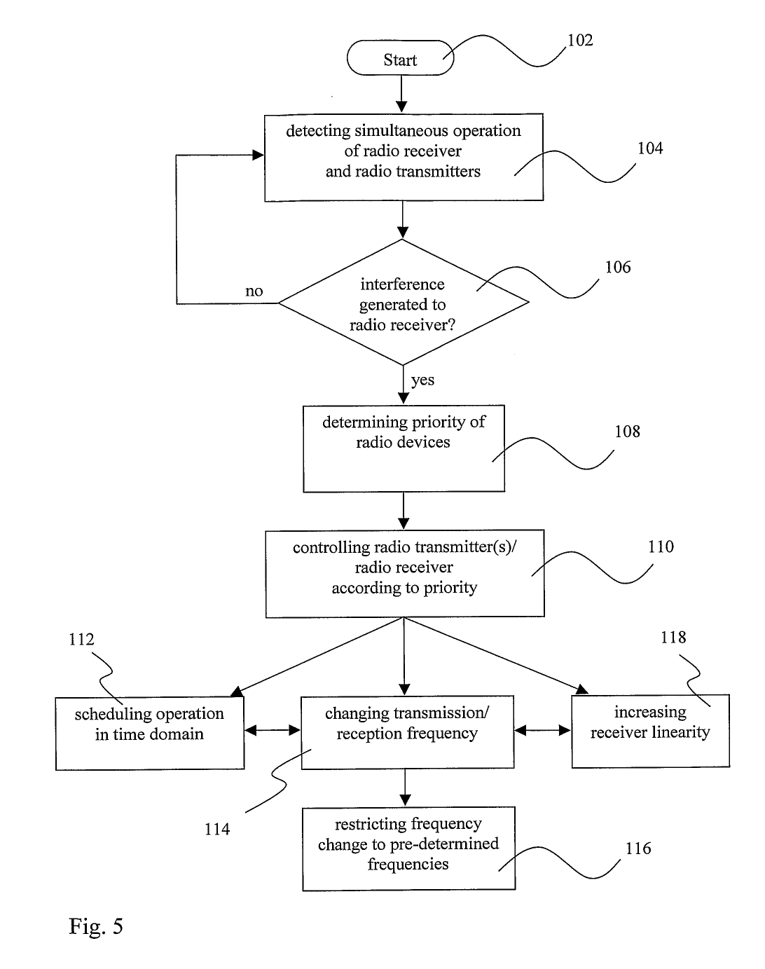

FIG. 5 is a flow diagram of an embodiment of the inventive method. After start in step 102 it is determined, if there are simultaneously operating radio receiver and radio transmitters, in step 104. As an example these devices may comprise a GPS receiver, a Bluetooth and a GSM transceiver. However there are other combinations possible, and even more than one receiver 110 and/or more than two transmitters. In step 106 a determination is performed, if the simultaneous operation of the two or more transmitters causes an interference affecting the radio receiver. E.g. the two transmitting devices may create an intermodulation signal falling into the receiver's reception band.

If no such interference is generated the process returns to step 104 again. Otherwise the process continues with step 108, where the priority of the operation of the radio devices is determined. As already described, the GSM link will apparently have a higher priority as the Bluetooth link. Losing connection during a speech call or like will hardly be accepted by a user, while (for a short time) losing connection with the user's personal computer will hardly be noticed by the user, or at least easily accepted. Prioritization is important for the present invention, in order to solve the object of ensuring optimal connectivity, however it is an optional step.

In step 110 the radio transmitter(s)/the radio receiver is controlled in order to take care of the detected interference situation. This controlling will be performed in accordance with the determined priority, that is, lower priority devices will be controlled first. Therefore, according to the detected situation and/or priorities involved, one of the radio transmitters may be controlled, the receiver may be controlled, or even all of these devices may be controlled. As an example, in case the radio receiver's operation is not crucial, simply the reception can be delayed as long as the two transmitters are transmitting. This may e.g. apply to the operation of a DVB-H receiver. It may not be suitable for a GPS/Galileo receiver.

Another example is to control just one of the transmitters, e.g. changing the frequency of the GSM device (900->1800 or vice versa), or adapting the Bluetooth transmission mode (activating retransmission with eSCO). However, under certain circumstances it may even be necessary to control both transmitters.

Controlling in step 110 may include one or a combination of the following steps. In step 112 the operation of one (or more) of the radio devices is scheduled in time domain. That means operation may be delayed, restricted to certain time periods or like. It may even include interrupting the operation of a device for a time period. In step 114 the transmission frequency of one of the radio transmitters is changed. This step may further include to restrict this change of frequency to pre-determined frequencies which are known to cause no or at least reduced interference (step 116). Still another possibility to deal with the interference situation relies in increasing the radio receiver's linearity, in step 118.

This controlling is continued until the interference is ceased, e.g. when one of the transmitter devices or the receiver device stops operating. For example if the user has ended his GSM telephone call, or if he disconnected a Bluetooth device connected with his terminal and switched of Bluetooth. It should be apparent for an artisan that the depicted process will be carried out in a continuous manner, in order to deal with changes in the situation/usage of the air interface.

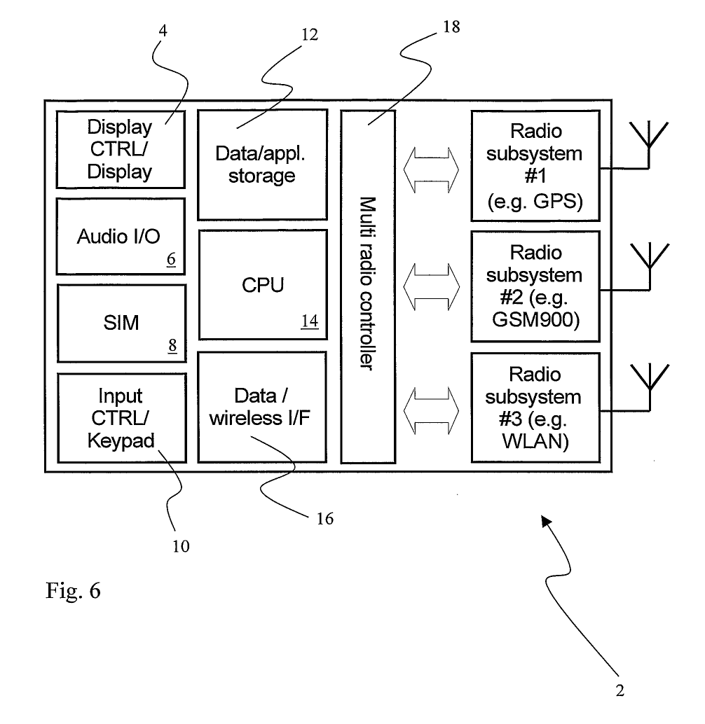

FIG. 6 illustrates a mobile terminal device 2 according to an embodiment of the present invention. The terminal comprises conventional components as a display controller 4, audio input/output interface 6, a SIM card interface 8, an input controller 10, a storage unit 12 for storing data and/or applications, and a CPU 14. In this exemplary terminal there are three different radio devices or radio subsystems, respectively, each one having its own antenna: Subsystem #1 is a GPS receiver, #2 is a GSM 900 transceiver, and #3 is a WLAN transceiver.

The terminal also comprises a multi radio controller (MRC) 18. The MRC is aware of ongoing radio connections of the terminal. The simultaneous operation of the radio receiver #1 and the two transmitters #2, #3 is determined to cause interference to the receiver #1. The multi radio controller 18 is also adapted to handle such interference situations, by controlling one of the three radio devices #1, #2, #3 in order to reduce or eliminate the interference. The methods according to which the multi radio controller 18 operates have already been described in conjunction with the method of the present invention.

There are basically two possibilities to control the radio devices, depending on the implementation of those radio interfaces. If the interfaces are implemented without their own control logic, that is, when they are directly controlled by the multi radio controller 18, the controller will have a very straight-forward control over the devices. If one or all of the radio devices are implemented as substantially independent RF modules like a Bluetooth module, the controller 18 will submit instructions to these modules in order to perform the controlling of the present invention. For example a Bluetooth module can be instructed to make use of special Bluetooth features like eSCO, AFH and the like. A WLAN module can be instructed to restrict its operation to certain frequencies/channels. If the method of the invention is to be performed in situations where the interference results from two or more transmitters not located within the terminal, the latter case, that is, sending instructions to these transmitters instead of direct controlling, can be used. Alternatively the terminal may not have means to control the transmitter(s) nearby. In this case the interference is avoided by controlling only the radios in the terminal.

The basic idea of the present invention is to provide means for enabling a multi radio controller of a terminal comprising multiple radio devices to detect situations where e.g. the GPS/Galileo receiver is affected by noise/interference due to the combined effects of radio devices operating simultaneously, and to provide various techniques for minimizing/avoiding the noise/interference encountered at the GPS/Galileo receiver.

According to embodiments of the invention the various interference avoidance schemes are controlled by a dedicated multi radio controller that can either control directly all of the radio interfaces, or alternatively, each or some of radio interface has a separate controller capable of receiving inputs from the multi radio controller or other radio devices to provide a suitable radio controlling scheme for various situations.

In the present invention the problem (and thus the input to the multi radio controller) is different from the known prior art solutions, due to the nature of noise/interference detected in the GPS/Galileo receiver, which in the present invention is a result of combined effects of more than one simultaneously operating radio interface.

The solutions according to the present invention take into consideration that the noise/interference is a result of combined effects of the concurrently operating radio interfaces, so the techniques for avoiding the interference are different than in situations addressed by the known prior art, where there is “direct” interference (from just a single interfering radio interface).

This invention discloses how the interferences/noise in GPS/Galileo reception, which is caused by harmonic and intermodulation effects of two or more radio frequency devices operating simultaneously, can be minimized by scheduling radio devices and/or selecting which radio/channel/mode is to be used. In other embodiments also the linearity of the GPS/Galileo receiver is increased (or power consumption is decreased) based on the determined interference level.

Exemplary solutions to achieve better GPS/Galileo performance in case of intermodulation interference from two or more other radio devices according to embodiments of the invention include:

Scheduling of interfering radio devices in time domain by way of actual scheduling or changing the operation mode into more flexible operation with respect to the time domain (e.g. making use of the retransmission feature of Bluetooth) during GPS/Galileo receive operation:

Such scheduling of interfering radio devices in time domain by a multi radio controller is carried out to avoid intermodulation interference to GSP/Galileo. This can be achieved by disabling one of the interfering radio transmitter devices, or by scheduling the interfering transmitters in time domain such that they are not transmitting at the same time instant during the GPS/Galileo reception process. Generally, possibilities to schedule or disable a cellular transmitter are quite limited, since the timing control resides in the network. However, the number of uplink multi-slots in GPRS operation can be restricted in case of GSM data connection, and discontinuous transmission could be utilized in WCDMA and cdma2000 if available.

Another possibility to perform scheduling is to utilize the discontinuous transmission (DTX) mode of GSM speech transmission. The interference from a cellular transmitter can be avoided if the GPS location update is scheduled to occur during these DTX periods. The DTX is a mode where GSM is not transmitting anything apart from the comfort noise (CN) packets once in 160 ms while the user is not actively speaking. During DTX mode the terminal is transmitting the comfort noise packets, but the interference for GPS is much lower than in case of active transmissions. The location update of GPS can take approximately some hundred milliseconds under good signal conditions (compare with the DTX period of integer multiples of 160 ms).

In case of Bluetooth and WLAN there are more capabilities available in the terminal to affect its activity timing. For example, for Bluetooth the link type, e.g. from Synchronous Connection-Oriented Link (SCO) to Extended SCO (eSCO) or the packet type can be changed, the use of retransmission (e.g. in eSCO) may be utilized, or the ACL transmission can be delayed if appropriate. FIG. 2 presents a case where an eSCO link is used. Delaying the transmission of data or acknowledgment would be possible for WLAN as well. In practice, scheduling/disabling of Bluetooth and WLAN should be prioritized over cellular radio scheduling, due to the abovementioned reasons.

The blanking solution of the prior art can additionally be combined with the above-mentioned DTX scheme or other time scheduling schemes such that if e.g. the location update lasts so long that the CN packets need to be transmitted, i.e. the interfering intermodulation burst can't be completely avoided, the GPS can be blanked during the active slots to further improve the performance.

Changing the operation frequency or preventing the use of certain channels to avoid that intermodulation products fall into the GPS receivers operational frequency band:

Such changing of the operation frequency/channel or avoiding certain channels can be performed by the multi radio controller to avoid that intermodulation products fall into the GPS/Galileo system band. Corresponding rules can be defined, in order to minimize the probability of an occurrence of interference. For example:
In case of IMD3 interference with GSM 1800 TX and a neighboring WCDMA transmitter, the lower GSM 900 band is used instead of 1800 MHz
In case of intermodulation interference from a WLAN/BT transmitter and a GSM/cdma2000 transmitter at 850/900 MHz, the higher cellular band at 1800/1900 MHz is used instead of 850/900 MHz band (for example, see FIG. 3)
In GSM the user equipment (UE) could restrictedly “select” the band, since the BCCH channel is typically located either in the lower or higher band. If the first band is favorable from the interference point of view, the UE could intentionally hide its capability of using the second band and thus induce using only the first band
If the multi radio controller observes that the used cellular frequencies and Bluetooth frequencies generate harmful intermodulation products, it can communicate to the Bluetooth radio device to make use of the Adaptive Frequency Hopping (AFH) feature of Bluetooth, preferably restricted to channels/frequencies which reduce the intermodulation. Naturally, this can be carried out only if the Bluetooth device is a master in the Bluetooth Pico net or the AFH reporting from a slave device is enabled
In case of WLAN connection establishment or a WLAN access point using a disadvantageous frequency/channel (from intermodulation point of view), the multi radio controller will instruct to select the safest channel, in order to minimize interference. In practice this means a prioritization of a certain access point or a change of the access point, based on the frequency/channel the access point is using

Scheduling the activity of the GPS/Galileo receiver in situations where the actual timing of the position information is not critical (in the context of this invention this applies similarly to controlling the operation of other receiver devices, with GPS/Galileo just being a prominent example):

Scheduling the activity of the GPS/Galileo receiver could be an option in some use cases, where the actual timing of the acquisition or position fix is not critical. Hence, the positioning fix can be delayed or be performed between the active periods of the other interfering radio devices, such that no intermodulation interference is present at the time when the GPS/Galileo receiver is active. In practice, the delay in positioning fix due to this arrangement is so small that in typical cases the user won't realize a delay at all. However, in case of emergency calls the delay in positioning determination may be forbidden/disabled.

Boosting GPS/Galileo receiver linearity during situations when interfering signals are present:

As the intermodulation effects are caused by the degree of non-linearity of the radio receiver device, reducing this non-linearity or increasing the linearity, respectively, can help to reduce the harmful effects of intermodulation. Increasing or “boosting” the GPS/Galileo receivers linearity is thus a possible solution when interfering signals are present, which however will entail an increase in power consumption. In contrast, when no interfering transmitters are active, the GPS/Galileo front-end linearity (and thus power consumption) can be reduced. Respectively, when interfering transmitters are active, the GPS/Galileo front-end linearity may be boosted to avoid IMD2 and IMD3 interference. An increase in power consumption of the receiver will occur during the boosting, but since boosting takes place only a fraction of time, the resulting average power consumption increase can be considered to be reasonable. Furthermore, if the reception situation can be improved the overall power consumption is not necessarily higher than without boosting, since a prolonged reception time for a positioning fix can probably be avoided.

The control information for GPS/Galileo front end boosting (high/low linearity) is received in the GPS/Galileo engine from e.g. the multi radio controller, based on the status of all radio devices in the UE.

For the present invention it is crucial to have synchronization (in time and frequency domain) between all radio devices which are integrated into the same UE. The radio devices should be scheduled/managed promptly to avoid overlapping of operation in time in cases where interference to other radio devices is generated and thus performance degradation occurs. The scheduling/management can be handled e.g. by a separate multi radio controller (MRC), or each radio devices engine schedules/manages itself, based on information received from other radio devices.

However, in the latter case some kind of priority must be assigned to each radio device. E.g. Bluetooth can be given a low priority, WLAN a normal priority and GSM a high priority. In such an arrangement each device can decide if it should restrict its operation according to the operational state of the other devices. That is, in the above mentioned case the BT device will know that it should limit its operation if the WLAN device is transmitting causing a probable intermodulation interference situation. In contrast the WLAN device will know that it may continue to operate normally, as the lower priority BT device will automatically restrict its operation.

FIG. 6 illustrates the general block diagram of a mobile terminal comprising a multi radio controller and GSM 900, Bluetooth and GPS radio devices. Important radio scheduling parameters from the multi radio control point of view are start and stop instants of transmission and reception, off-time duration, periodicity of the activity and channel/frequency. The radio devices communicate the abovementioned important radio parameters to the controller, and based on the obtained information the controller makes its decisions on required scheduling of the radio devices and/or linearity boosting of the GPS receiver. The seriousness of the interference situation is determined by the controller based on the frequencies of the potential intermodulation products obtained from solving the equation given earlier or from preliminary assigned tables determining how to operate under certain circumstances. Moreover, GPS receiver signal quality measurement results or performance in (a) previous fixing attempt(s) can be used as a decision parameter.

The present invention provides inter alia the following advantages:
Savings in cost, reduction in power consumption and/or size (same performance could be achieved with less filtering, or same performance with lower power consumption)
Performance improvement; some use cases are degraded or not possible with current implementation, e.g. GPS & GSM 1800 GPRS (multi-slot), simultaneous usage of GPS & GSM & WLAN
Increased flexibility, shortened time-to-market (trend in implementation: from HW to SW, i.e. complex filtering means can be avoided)

1. A method, comprising:
detecting simultaneous operation of at least two radio transmitter devices and a radio receiver device;
determining that said simultaneous operation of said transmitter devices causes interference through frequency intermodulation effects at said radio receiver device; and
controlling at least one of said radio transmitter devices and/or said radio receiver device, in order to reduce said interference.

2. The method according to claim 1, wherein said controlling comprises:
scheduling the operation of at least one of said radio transmitter devices and/or of said radio receiver device in time domain, in order to prevent simultaneous operation of said radio transmitter devices and said radio receiver device.

3. The method according to claim 1, wherein said controlling comprises:
changing the transmission frequency of at least one of said radio transmitter devices and/or the reception frequency of said radio receiver device, in order to reduce said frequency intermodulation effects at said radio receiver device.

4. The method according to claim 3, further comprising:
restricting the change of the transmission or reception frequencies to pre-determined frequencies.

5. The method according to claim 1, wherein said controlling comprises:
increasing the linearity of said radio receiver device, in order to reduce said frequency intermodulation effects at said radio receiver device.

6. The method according to claim 1, wherein said controlling comprises:
determining a priority of the operation of said radio transmitter devices and/or said radio receiver device; and
performing said controlling of said radio transmitter devices and/or said radio receiver device in accordance with said priority.

7. The method according to claim 1, wherein said controlling is performed by sending a message to said at least one of said radio transmitter devices and/or said radio receiver device, said message including instructions for controlling said at least one of said radio transmitter devices and/or said radio receiver device.

8. The method according to claim 1, wherein said radio receiver device is
a broadcast receiver;
a positioning system receiver;
a cellular telephone receiver;
a wireless local area network receiver;
a wireless personal area network receiver; or
a wireless metropolitan area network receiver.

9. The method according to claim 1, wherein each of said radio transmitter devices is selected from the group comprising:
a cellular telephone transmitter;
a wireless local area network transmitter;
a wireless personal area network transmitter; and
a wireless metropolitan area network transmitter.

10. A computer program product comprising program code stored on a computer readable medium for carrying out the method of claim 1 when said program code is run on a computer or network device.

11. (canceled)

12. An apparatus, comprising:
a detection component, configured for detecting simultaneous operation of at least two radio transmitter devices and a radio receiver device, and for determining that said simultaneous operation of said transmitter devices causes interference through frequency intermodulation effects at said radio receiver device; and
a controller responsive to said detection component, configured for controlling at least one of said radio transmitter devices and/or said radio receiver device for reducing said interference.

13. The apparatus according to claim 12, wherein said controller is further configured for:
scheduling the operation of at least one of said radio transmitter devices and/or of said radio receiver device in time domain, in order to prevent simultaneous operation of said radio transmitter devices and said radio receiver device.

14. The apparatus according to claim 12, wherein said controller is further configured for:
changing the transmission frequency of at least one of said radio transmitter devices and/or the reception frequency of said radio receiver device, in order to reduce said frequency intermodulation effects at said radio receiver device.

15. The apparatus according to claim 14, wherein said controller is further configured for:
restricting the change of the transmission or reception frequencies to predetermined frequencies.

16. The apparatus according to claim 12, wherein said controller is further configured for:
increasing the linearity of said radio receiver device, in order to reduce said frequency intermodulation effects at said radio receiver device.

17. The apparatus according to claim 12, wherein said controller is further configured for:
determining a priority of the operation of said radio transmitter devices and/or said radio receiver device; and
performing said controlling of said radio transmitter devices and/or said radio receiver device in accordance with said priority.

18. The apparatus according to claim 12, wherein said controller is further configured for performing said controlling by sending a message to said at least one of said radio transmitter devices and/or said radio receiver device, said message including instructions for controlling said at least one of said radio transmitter devices and/or said radio receiver device.

19. A mobile electronic device, comprising an apparatus according to claim 12.

20. The mobile electronic device according to claim 19, further comprising a radio receiver device.

21. The mobile electronic device according to claim 20, wherein said radio receiver device is selected from the group comprising:
a broadcast receiver;
a positioning system receiver;
a cellular telephone receiver;
a wireless local area network receiver;
a wireless personal area network receiver; and
a wireless metropolitan area network receiver.

22. The mobile electronic device according to claim 19, further comprising at least two radio transmitter devices.

23. The mobile electronic device according to claim 22, wherein said radio transmitter devices are selected from the group comprising.
a cellular telephone transmitter;
a wireless local area network transmitter;
a wireless personal area network transmitter; and
a wireless metropolitan area network transmitter.

24. An apparatus, comprising:
means for detecting simultaneous operation of at least two radio transmitter devices and a radio receiver device, and for determining that said simultaneous operation of said transmitter devices causes interference through frequency intermodulation effects at said radio receiver device; and
means for controlling at least one of said radio transmitter devices and/or said radio receiver device for reducing said interference.
